(19) United States
(12) Patent Application Publication
(10) Pub. No.: US 2025/0010748 A1
(43) Pub. Date: Jan. 9, 2025

(54) Method and apparatus for wireless charging of stopped and driving electric vehicles using two-way communications

(71) Applicant: WIPOWERONE.INC, Daejeon (KR)

(72) Inventors: Guk-Hyun LEE, Sejong (KR); Yi-Geun LEE, Daejeon (KR)

(21) Appl. No.: 18/822,622

(22) Filed: Sep. 3, 2024

Related U.S. Application Data
(63) Continuation of application No. PCT/KR2023/002136, filed on Mar. 14, 2023.

(30) Foreign Application Priority Data
Mar. 3, 2022 (KR) 10-2022-0027250
Jul. 25, 2022 (KR) 10-2022-0091588

(51) Int. Cl. B60L 53/39; B60L 53/122; B60L 53/62; B60L 53/65; B60L 53/66; H02J 50/80

(52) U.S. Cl. CPC B60L 53/39; B60L 53/122; B60L 53/62; B60L 53/65; B60L 53/66; H02J 50/80

(57) ABSTRACT

A method and device for wireless charging of electric vehicles, both stationary and in motion, is provided. Two-way RF communication establishes a dynamic link between the vehicle and the power supply, enabling real-time segment switching for efficient power delivery. The system actively assesses the vehicle's charging needs and location to optimize power transfer, reducing communication overhead and improving charging efficiency. This bidirectional 10 communication approach enhances the reliability and adaptability of wireless charging infrastructure for electric vehicles.

### BACKGROUND OF THE INVENTION

### 1. Field of the Invention

The present invention relates to a method and device for wireless charging of stationary and moving electric vehicles. More specifically, the present invention relates to a method and device for wireless charging of stationary and moving electric vehicles using two-way communication, wherein wireless coupling between the electric vehicle and the power supply electronic device is achieved using two-way RF communication, and segments are switched in real time to supply power to the stationary and moving electric vehicles.

### 2. Description of the Related Art

In wireless charging of moving electric vehicles, the electric vehicle periodically generates a signal, which is acquired by a sensor installed on the road where the power supply line is buried. Then, the power supply device checks the presence of the electric vehicle through the sensor and performs wireless charging. This is a one-way communication transmission method.

This one-way communication transmission method for wireless charging does not have a separate confirmation procedure for checking communication reliability. Therefore, regardless of whether the power supply device has received the transmission signal when the electric vehicle sends it, the electric vehicle continuously and periodically transmits the signal, which increases the uncertainty of communication for wireless charging.

In addition, when two or more electric vehicles continuously and periodically transmit signals, communication failures may occur due to a surge in the amount of signals. There is also the issue of determining segment switching of the power supply device based on the RF signal sent from the electric vehicle.

### SUMMARY OF THE INVENTION

The present invention has been made to solve the above-mentioned problems. An object of the present invention is to provide a method and device for wireless charging of stationary and moving electric vehicles using two-way communication, which enables wireless coupling between the electric vehicle and the power supply electronic device using two-way RF communication, and performs segment switching based on high-speed communication-based location determination.

To accomplish this objective, according to an aspect of the present invention, there is provided a method for wireless charging of stationary and moving electric vehicles using two-way communication by one or more supply power electronic devices, the method comprising: (a) transmitting a periodic RF signal through at least one supply power P2P communication controller by the supply power electronic device; (b) checking whether a response signal to the RF signal transmitted in step (a) is received; (c) checking, if the response signal is received in step (b), a wireless charging required value of the received response signal; and (d) determining on/off switching of a segment where the supply power P2P communication controller is located, according to the checking result of the step (c).

According to another aspect of the present invention, there is also provided a device for wireless charging of stationary and moving electric vehicles using two-way communication by one or more supply power electronic devices, the device comprising: at least one processor; and at least one memory storing computer-executable instructions, wherein the computer-executable instructions stored in the at least one memory, when executed by the at least one processor, cause the device to perform: (a) transmitting a periodic RF signal through at least one supply power P2P communication controller by the supply power electronic device; (b) checking whether a response signal to the RF signal transmitted in step (a) is received; (c) checking, if the response signal is received in step (b), a wireless charging required value of the received response signal; and (d) determining on/off switching of a segment where the supply power P2P communication controller is located, according to the checking result of the step (c). According to still another aspect of the present invention, there is provided a method for wireless charging of stationary and moving electric vehicles using two-way communication, the method comprising: (a) receiving an RF signal by a vehicle P2P communication controller of the electric vehicle; (b) identifying an ID of a supply power electronic device from the RF signal received in the step (a); and (c) transmitting a response signal including a wireless charging required value to the supply power electronic device identified in the step (b) and turning on/off a battery switch of the electric vehicle.

The invention enables rapid segment switching through location selection based on high-speed communication using RF signals.

The invention also reduces communication failures by decreasing the amount of signals generated from the electric vehicle.

### BRIEF DESCRIPTION OF THE DRAWINGS

FIG. 1 is a diagram illustrating an overall system structure for wireless charging of stationary and moving electric vehicles using two-way communication, according to an embodiment of the present invention.

FIG. 2 is a flowchart illustrating a first embodiment of a method for wireless charging of stationary and moving electric vehicles using two-way communication, according to the present invention.

FIG. 3 is a flowchart illustrating a second embodiment of a method for wireless charging of stationary and moving electric vehicles using two-way communication, according to the present invention.

FIG. 4 is a diagram illustrating a message sequence chart (MSC) between a power supply electronic device and an electric vehicle, according to the present invention.

FIG. 5 is a diagram illustrating a message sequence chart (MSC) illustrating power off procedures in response to various conditions, according to the present invention.

FIG. 6 is a diagram for explaining segment switching in a wireless charging system for stationary and moving electric vehicles using two-way communication, according to the present invention.

FIG. 7 is a diagram for explaining an individual segment switching procedure during segment switching in the wireless charging system for stationary and moving electric vehicles using two-way communication, according to the present invention.

FIG. 8 is a diagram for explaining group segment switching during segment switching in the wireless charging system for stationary and moving electric vehicles using two-way communication, according to the present invention.

FIG. 9 is a diagram for explaining segment switching designated as an overlapped group during segment switching in the wireless charging system for stationary and moving electric vehicles using two-way communication, according to the present invention.

FIG. 10 is a diagram for explaining a situation where a response message transmitted from an electric vehicle reaches a plurality of segments in the wireless charging system for stationary and moving electric vehicles using two-way communication, according to the present invention.

FIG. 11 is a diagram for explaining a situation where two or more response messages are delivered in one segment in the wireless charging system for stationary and moving electric vehicles using two-way communication, according to the present invention.

FIG. 12 is a diagram illustrating the possibility of segment switching between SPEs when there are two or more SPEs in the wireless charging system, according to the present invention.

FIG. 13 is a diagram illustrating a procedure for in-motion charging and switching between SPEs when there are two SPEs in the wireless charging system, according to the present invention.

### DETAILED DESCRIPTION OF THE INVENTION

Hereinafter, embodiments of the present invention will be described in detail with reference to the accompanying drawings. The same or similar components will be denoted by the same or similar reference numerals, and redundant descriptions thereof will be omitted. In describing the embodiments disclosed in the present specification, detailed descriptions of related known technologies will be omitted if it is determined that such detailed descriptions may obscure the gist of the embodiments disclosed in the present specification. The accompanying drawings are provided to help easily understand the embodiments disclosed in the present specification, and the technical idea disclosed in the present specification is not limited by the accompanying drawings. The present invention should be understood to include all modifications, equivalents, or substitutes within the spirit and scope of the present invention.

Terms including ordinal numbers, such as “first,” “second,” etc., may be used to describe various components, but such terms are used only for the purpose of distinguishing one component from another, and the corresponding components are not limited by such terms. The singular forms “a,” “an,” and “the” include plural referents unless the context clearly dictates otherwise.

The terms “comprise,” “have,” or “include” used in the present specification should be understood to specify the presence of the features, steps, components, or combinations thereof described in the specification, and do not exclude the possibility of one or more features, steps, components, or combinations thereof being present or added.

When a component is described as being “connected” or “coupled” to another component, it may be directly connected or coupled to the other component, or there may be another component interposed therebetween. On the other hand, when a component is described as being “directly connected” or “directly coupled” to another component, it should be understood that there is no other component interposed therebetween.

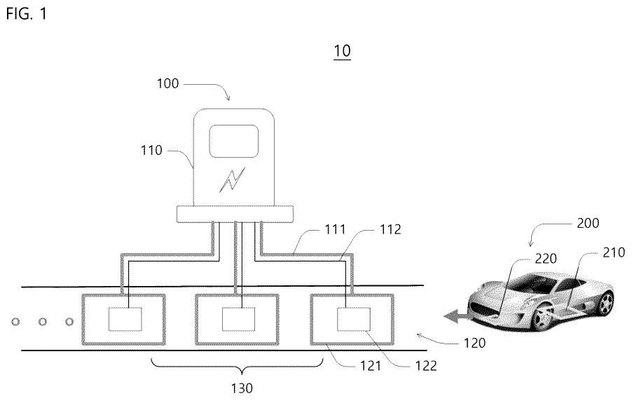

FIG. 1 is a diagram illustrating an overall system structure for wireless charging of stationary and moving electric vehicles using two-way communication, according to an embodiment of the present invention.

Referring to FIG. 1, the overall system 10 for wireless charging of stationary and moving electric vehicles using two-way communication, according to the present invention, includes a wireless power transmission charging unit 100 and an electric vehicle 200. The wireless power transmission charging unit 100 includes a supply power electronics (SPE) 110 for providing power for wireless charging to the stationary and moving electric vehicles, a supply power line 111, a P2P (Point-to-point) communication line 112, a rechargeable area 120, a supply power P2PC controller (SPPC) 122, a segment (primary device) 121, and a segment group (primary device group) 130. A vehicle P2P communication controller (VPC) 220 and a power pick-up device (secondary device) 210 are installed in the electric vehicle 200.

In the overall system 10 for wireless charging of stationary and moving electric vehicles using two-way communication of FIG. 1, the wireless power transmission charging unit 100 performs wireless coupling with the stationary and moving electric vehicle 200. Specifically, when the electric vehicle 200 is in the rechargeable area 120, the SPE 110 recognizes the presence of the electric vehicle 200 and powers on the supply power line 111. When the electric vehicle 200 is not in the rechargeable area 120, the SPE 110 recognizes the absence of the electric vehicle 200 and powers off the supply power line 111. This is achieved through two-way communication. Here, the segment 121 is the minimum unit that the SPE 110 can power on/off, and the power of each segment 121 is turned on/off through the SPE 110. The SPPC 122 is a device for transmitting/receiving RF signals. It transmits the RF signal received from the outside, i.e., the electric vehicle 200, to the SPE 110, and transmits the signal received d from the SPE 110 to the outside, i.e., the electric vehicle 200, as an RF signal. In this case, one SPPC 122 is installed for each segment 121.

The VPC 220 installed in the electric vehicle 200 is also a device for transmitting/receiving RF signals. It transmits the RF signal received from the outside, i.e., the SPE 110, to the EV control device (not shown) of the electric vehicle 200, and transmits the signal received from the EV control device to the outside, i.e., the SPE 110, as an RF signal. In this case, at least one VPC 220 is installed per electric vehicle 200. The basic operation is as follows: First, the SPPC 122 sends an RF signal, which is a broadcast (BC) signal. This signal is sent continuously and periodically even in normal times. Then, the VPC 220 receives the RF signal. The VPC 220 then sends a response signal to the RF signal. Then, the SPPC 122 recognizes that the electric vehicle 200 has entered by checking the content of the response signal. At this time, the SPPC 122 turns on the power of the segment 121 at the corresponding location of the electric vehicle 200. When the speed of the electric vehicle 200 is high, the segment can be set to group switching to predict the entry of the electric vehicle 200 and turn on the segment power in advance.

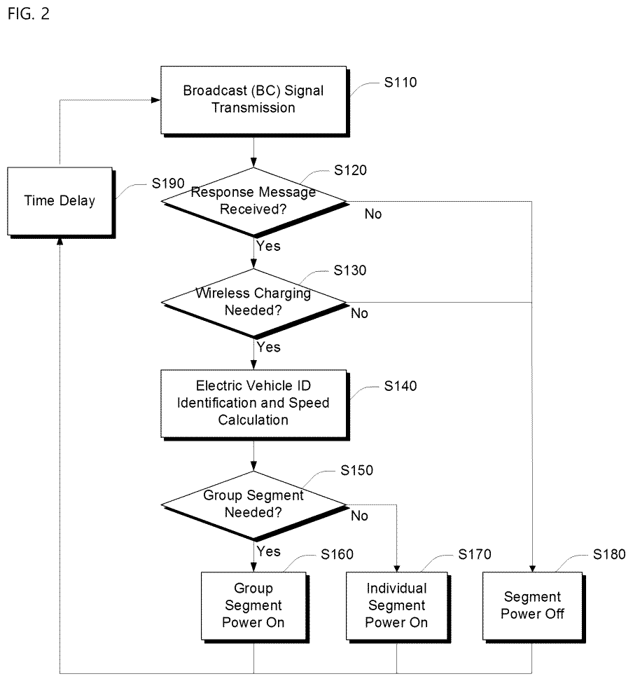

The wireless charging method between the SPE 110 of the wireless power transmission charging unit 100 and the electric vehicle 200 through the overall system 10 for wireless charging of stationary and moving electric vehicles using two-way communication will be described in detail below with reference to FIGS. 2 to 13.

FIG. 2 is a diagram illustrating a first embodiment of a method for wireless charging of stationary and moving electric vehicles using two-way communication, according to the present invention, which is a flowchart illustrating a wireless charging process according to the transmission/reception operation flow of one or more SPEs.

Referring to FIG. 2, one or more SPEs transmit a broadcast (BC) signal through at least one supply power P2P communication controller (S110).

Then, it is checked whether a response message to the broadcast signal transmitted in step S110 is received (S120). If a response message to the broadcast signal transmitted in step S110 is received, the received response message is parsed to check whether wireless charging is required (S130). Here, whether wireless charging is required is determined according to the value of “Need_Power” of the received response message. If “Need_Power” is “0”, wireless charging is not required, and if “Need_Power” is “1”, wireless charging is required.

On the other hand, if a response message to the broadcast signal transmitted in step S110 is not received, the segment power is turned off (S180).

If wireless charging is required as a result of checking whether wireless charging is required in step S130, the electric vehicle ID is identified and the speed is calculated (S140). If wireless charging is not required, the segment power is turned off (S180).

Then, it is checked whether a group segment is required according to the speed of the electric vehicle ID calculated in step S140 (S150). If a group segment is required, the group segment power is turned on (S160). If a group segment is not required, the individual segment power is turned on (S170). After a predetermined time delay (S190), the SPE transmits a broadcast (BC) signal through at least one supply power P2P communication controller 110.

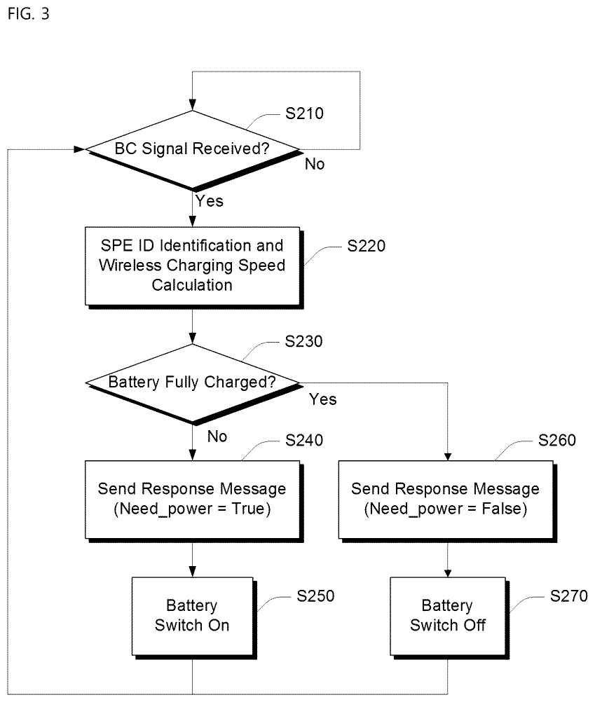

FIG. 3 is a flowchart illustrating a transmission/reception operation flow at the electric vehicle side, which is a second embodiment of a method for wireless charging of stationary and moving electric vehicles using two-way communication, according to the present invention.

Referring to FIG. 3, the electric vehicle checks whether a broadcast signal has been received through the VPC (S210). If not, it continues to check for reception. If a broadcast signal has been received, it identifies the SPE ID and calculates the speed (S220).

Next, the electric vehicle checks whether its battery is fully charged (S230). If not fully charged, it sends a response message indicating the need for wireless charging (Need_Power=True) to the identified SPE and turns on the battery switch (S240-S250). If fully charged, it sends a response message indicating no need for wireless charging (Need_Power=False) to the identified SPE and turns off the battery switch (S260-S270).

As such, the electric vehicle receives a broadcast signal and sends a response message depending on whether the battery is fully charged. The response message includes the value of Need_Power and is sent to the SPE. In addition to the battery status, the driver can also set Need Power to 0 through manipulation if they do not want to charge. That is, Need_Power=0 if the battery is fully charged, and Need_Power=1 if the battery is not fully charged.

The message format for RF signal exchange between the SPPC and the VPC consists of a header, body, and tail structure. The header is a part for distinguishing consecutive packets and contains the same content in all messages. The body contains meaningful information, and the content of the message sent from the SPE to the electric vehicle and the message sent from the electric vehicle to the SPE are different. For example, “SPE_ID” in the message sent from the SPE to the electric vehicle is the unique identification number of the SPE. In the message sent from the electric vehicle to the SPE, “SPE_ID” is the unique identification number of the SPE, and “EV_ID” is the unique identification number of the EV. “Need_Power” has a value of True/False and indicates whether or not to receive wireless charging, “Power_to_Charge” indicates the required charging power, and “Velocity” indicates the speed of the vehicle. “State_Code” indicates a normal state/error state, and in the error state, the type of error is expressed as an error Finally, the tail includes a CRC to ensure the reliability of message transmission.

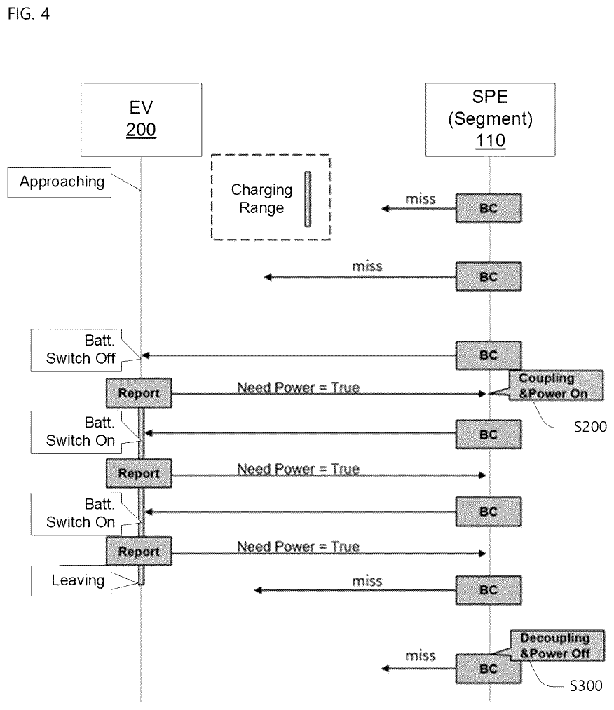

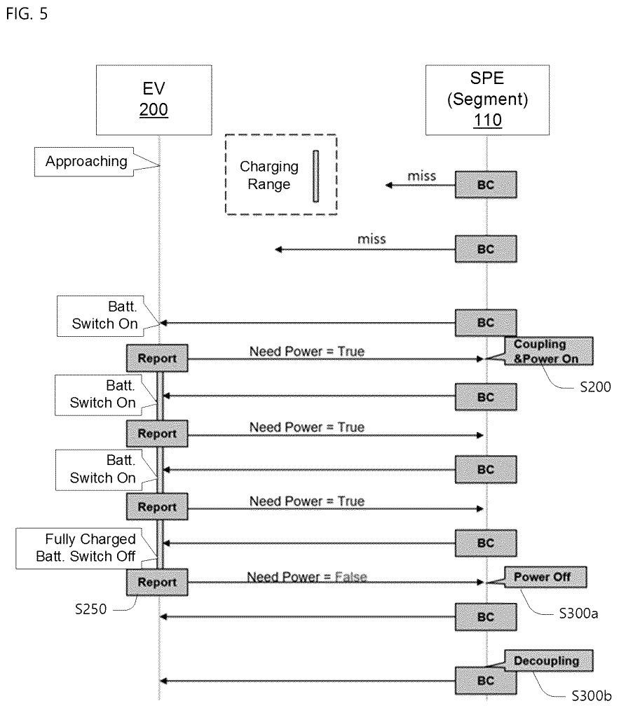

FIGS. 4 and 5 are diagrams illustrating a message sequence chart (MSC) between a power supply electronic device and an electric vehicle, according to the present invention.

First, referring to FIG. 4, the SPE 110 periodically and continuously sends BC (Broadcast) information, which is charging infrastructure system information, to the electric vehicle 200 through the SPPC. Here, the BC signal is not directed to a specific electric vehicle 200, but is delivered to unspecified electric vehicles 200 in proximity.

Then, the electric vehicle 200 sequentially transmits a response (Report) message to the BC signal to the SPE 110. In this case, the start of power transmission (Power On) (S200) of the segment starts after coupling is established when a response message to the broadcast (BC) information from the electric vehicle 200 is received at the SPPC (S200). Here, it is assumed that the wireless charging required response message is “Need_Power =True”, and the response message sent by the electric vehicle 200 is received through the SPPC, but from now on, for convenience, it is expressed that the segment receives the response message. Here, coupling means that the SPE 110 has checked the electric vehicle that is currently receiving the charging service through the electric vehicle_ID inside the response message, and it is independent of the segment power on/off state and means the connection establishment state on the RF signal. Coupling takes place only between one segment and one electric vehicle. Coupling (S200) occurs when the segment receives a response message, and is valid until the timeout of the next response message reception. Therefore, if a response message is not received at least once for BC transmission, the coupling is released (S300). That is, the process of the segment stopping power transmission (Power Off) is when the coupling is released, and the SPE 110 turns off the power of the corresponding segment. In other words, it is determined that the electric vehicle has left the charging zone, so the coupling is released due to the BC non-response, and the power-off process is performed due to this.

Referring to FIG. 5, if the content of the response message (S250) received by the segment is “Need_Power=False”, that is, if a wireless charging unnecessary response message is received, the corresponding segment is powered off (S300a). In this case, if the electric vehicle 200 being charged has completed charging more than 90% of the battery, an abnormal state has occurred inside the electric vehicle, or the driver refuses wireless charging by disabling it, the charging can be stopped through a wireless charging unnecessary response message, and then decoupling occurs (S300b). Also, even if the coupling is released or the segment receives a response message, if it is not coupled with the electric vehicle, it will be powered off. However, in the overlapped segment group switching method, which will be described later, the power-on state can be maintained even if the coupling is released.

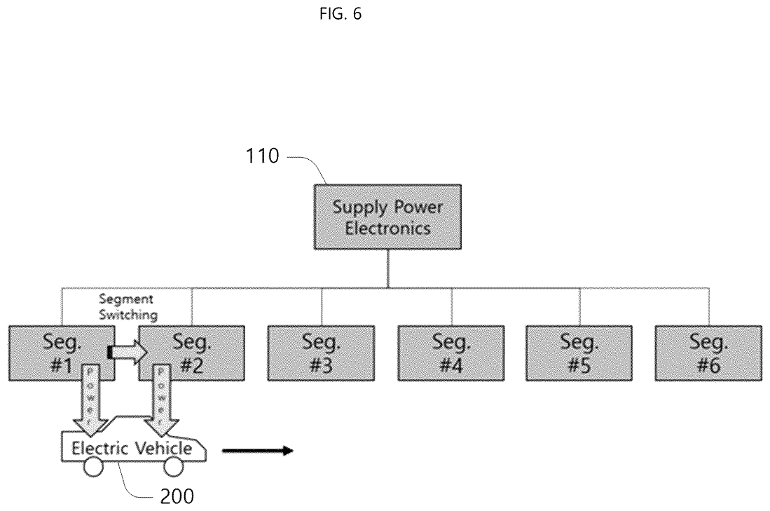

FIG. 6 is a diagram for explaining segment switching in a wireless charging system for stationary and moving electric vehicles using two-way communication, according to the present invention.

Referring to FIG. 6, segment switching means that in an in-motion wireless charging system, the next segment is powered on just before the electric vehicle being charged moves to the next segment, and the existing segment is powered off after the segment movement. That is, it means that the electric vehicle 200 shown in FIG. 6 is being charged in seg. #1, and seg. #2 is powered on just before moving to seg. #2, and seg. #1 is powered off after moving to seg. #2.

In other words, in the segment switching of the present invention, the electric vehicle 200 transmits a response message to the BC to the SPE 110 while driving. Then, the response message reaches the SPPC of the SPE 110, and at this time, the segment of the SPPC that received the response message is powered on. On the other hand, the segments of the SPPC that did not receive the response message are powered off. At this time, due to the characteristics of RF signals, response messages can be received by multiple SPPCs, and the method for determining which SPPC's response message to select among the multiple SPPCs that received the response message will be described later.

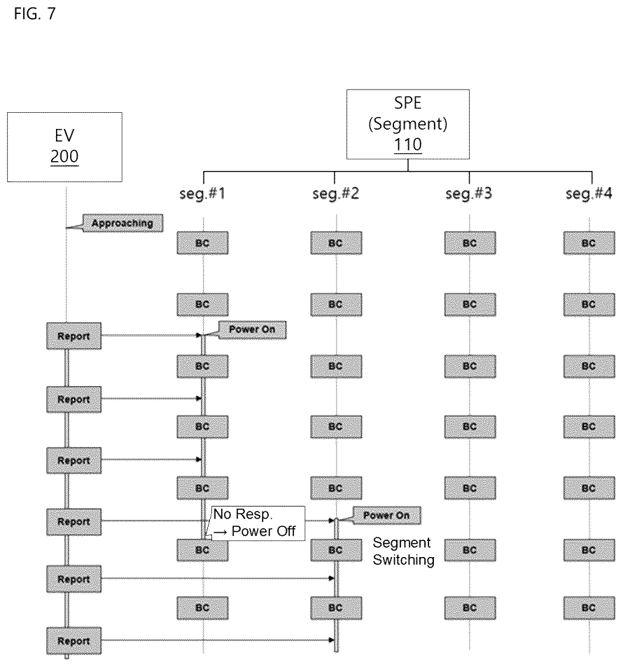

FIG. 7 is a diagram for explaining an individual segment switching procedure during segment switching in the wireless charging system for stationary and moving electric vehicles using two-way communication, according to the present invention.

Referring to FIG. 7, the segment switching is shown in a time diagram when the electric vehicle 200 is driving on a wireless charging road. It shows that the segment is powered off because there is no response message received for a certain period of time in seg. #1, and the segment is powered on because a response message is received in seg. #2. This is a method of controlling the segments one by one. It has the advantage that only the necessary segments can be powered on/off according to the position of the electric vehicle. However, when the driving speed of the electric vehicle is high, it is difficult to power on/off at an appropriate timing because the transmission period of BC is relatively long. Also, delays caused by the electrical charging time of the segment and the operation time of the control board of the SPE make it difficult to power on/off at an appropriate timing. If the SPE powers on only seg. #1 when the electric vehicle 200 enters, there is a concern that the electric vehicle will be located at seg. #3 when the next BC information is transmitted. Therefore, the electric vehicle may not be able to charge when passing seg. #2.

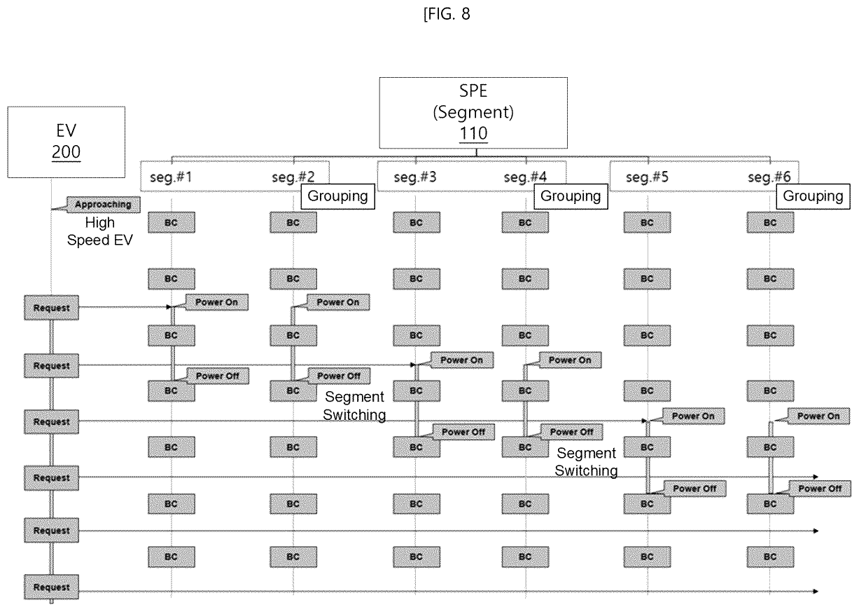

FIG. 8 is a diagram for explaining segment switching designated as separated groups during group segment switching in the wireless charging system for stationary and moving electric vehicles using two-way communication, according to the present invention.

Group segment switching means that when performing segment switching, n or more segments are designated as a group and powered on/off together. How many segments will be designated as a group is determined according to the speed of the electric vehicle. That is, group segment switching is performed when the driving speed of the electric vehicle traveling on the segment is high. Referring to FIG. 8, the SPE 110 groups two segments according to the driving speed of the electric vehicle and powers them on/off simultaneously. Seg. #1 and seg. #2, seg. #3 and seg. #4, and seg. #5 and seg. #6 are grouped and segment switching is performed, which is a method of designating the segments as separated groups.

That is, segment switching is divided into individual segment switching or group segment switching, and in group segment switching, it is determined how many segments will be grouped. In this case, segment switching is determined based on the driving speed of the electric vehicle. The driving speed of the electric vehicle can be checked by combining the following two methods. First, it is a method using the speed (velocity) data inside the response message, and the SPE 110 checks the driving speed of the electric vehicle 200 by checking the speed data in the response message. This is determined by comprehensively considering the driving speed, the segment interval, and the BC information transmission period. If it is determined that n segments will pass in one BC information transmission, n segments are grouped and group segment switching is performed. The other method is a method using the response message reception time interval, and the SPE calculates the driving speed of the corresponding electric vehicle using the time interval between the response message signal received in seg. #1 and the response message signal received in seg. #3. This is determined by comprehensively considering the driving speed, the segment interval, and the BC information transmission period. If it is determined that n segments will pass in one BC information transmission, n segments are grouped and group segment switching is performed.

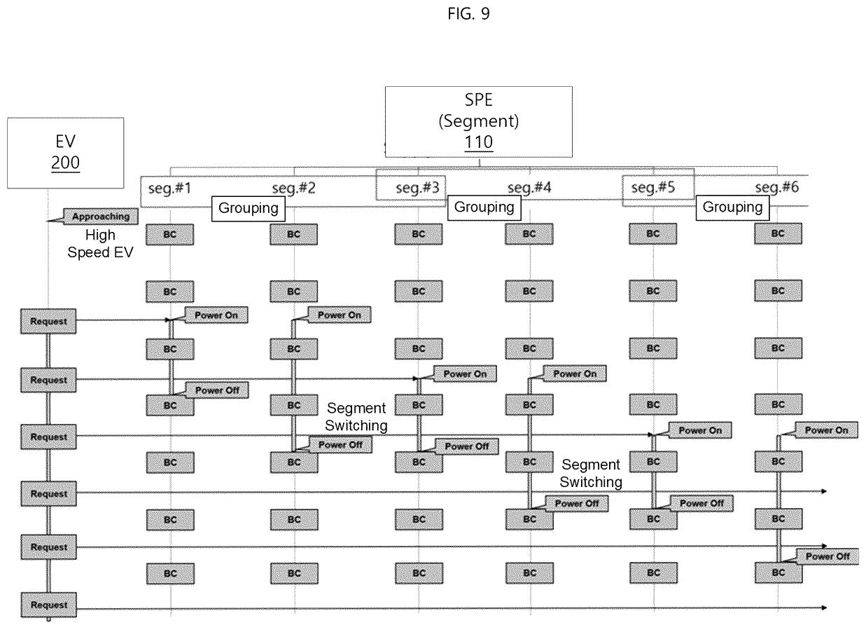

FIG. 9 is a diagram for explaining segment switching designated as overlapped groups during group segment switching in the wireless charging system for stationary and moving electric vehicles using two-way communication, according to the present invention.

Segment switching designated as overlapped groups during segment switching means that when performing group segment switching, m segments are grouped and n segments are overlapped to switch the group segments. (where m>n>0,and m and n are natural numbers, and m>1)

Referring to FIG. 9, it shows that group segment switching is performed by grouping the segments into three and overlapping one segment. (m=3, n=1)

That is, seg. #1 to 3, seg. #3 to 5, and seg. #5 to 7 are grouped, and it shows that seg. #3 and seg. #5 are overlapped when performing segment switching.

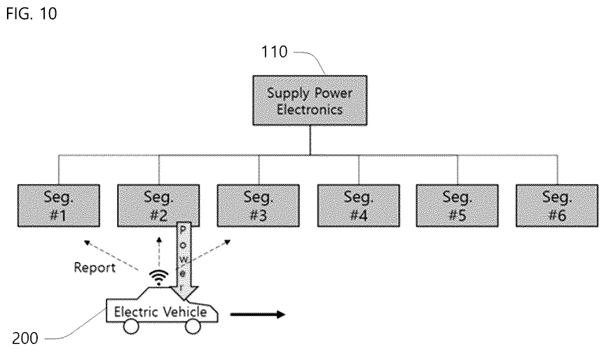

FIG. 10 is a diagram for explaining a situation where a response message transmitted from an electric vehicle reaches a plurality of segments in the wireless charging system for stationary and moving electric vehicles using two-way communication, according to the present invention.

Referring to FIG. 10, the message exchange between the

SPE 110 and the electric vehicle 200 is based on RF communication. Therefore, the response message signal sent by the electric vehicle 200 reaches a plurality of SPPCs, that is, a plurality of segments. The SPE 110 needs to turn on the power of a specific segment to supply power, and the

SPE 110 determines the segment to be powered on based on the strength of the RF signal. FIG. 10 shows a situation where the response signal transmitted by the electric vehicle 200 reaches seg. #1 to 3. On the other hand, the SPE 110 responds only to RF signals above the threshold level among the RF signal strengths received on the SPE side, and the segment with the largest strength among the RF signals above the threshold level is selected and powered on.

In addition, in order to determine which electric vehicle the segment that has been powered on will be coupled with, the SPE checks the electric vehicle ID in the content of the response message received at the segment. However, if there are multiple electric vehicles nearby, multiple response messages may be received at one segment, and the response signal strength of an electric vehicle far from the segment may be greater due to reflection and superposition of RF signals.

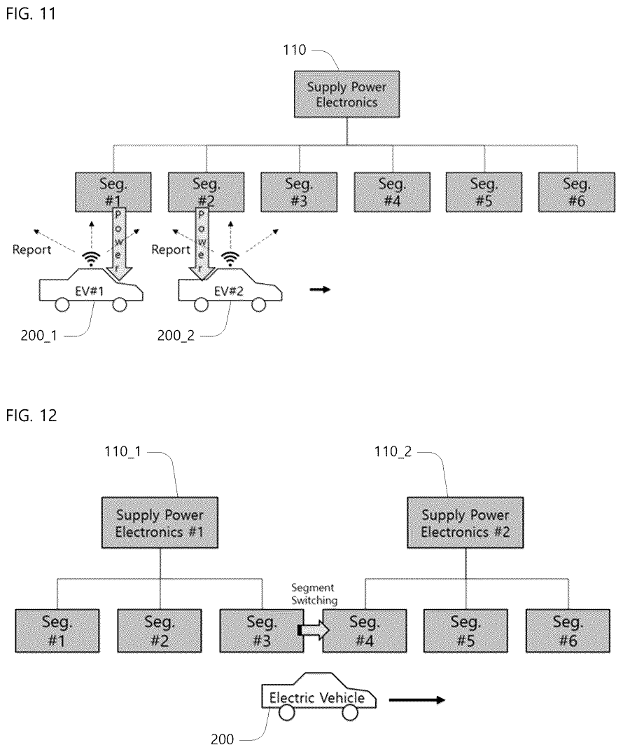

FIG. 11 is a diagram for explaining a situation where two or more response messages are delivered in one segment in the wireless charging system for stationary and moving electric vehicles using two-way communication, according to the present invention.

As explained in FIG. 10, it is difficult to identify a specific electric vehicle solely based on the magnitude of the RF signal. Therefore, the electric vehicle is identified based on the coupling information of the previous segment. When the segment installed in seg. #2 of FIG. 11 receives a response message, two or more response messages may be received. In this case, the SPE identifies the electric vehicle coupled with seg. #2 as the electric vehicle that was coupled with seg. #1 immediately before in time. That is, it is determined that the electric vehicle has moved the segment over time. In this process, the electric vehicles are distinguished based on the electric vehicle_ID. That is, if there is only one response message received, there is no problem in identifying the electric vehicle. However, if there are multiple response messages, a procedure for checking the electric vehicle coupled with the previous segment is performed.

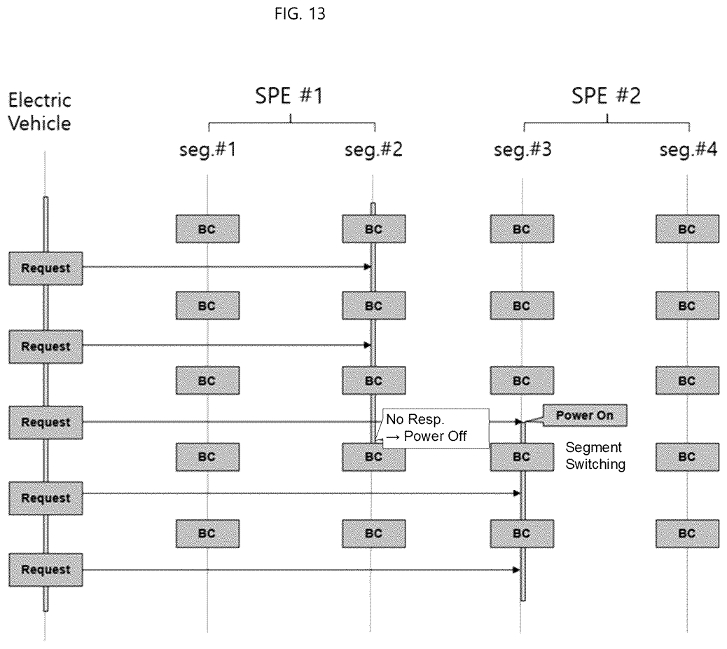

FIGS. 12 and 13 are diagrams illustrating a procedure for in-motion charging and switching between SPEs when there are two SPEs in the wireless charging system for stationary and moving electric vehicles using two-way communication, according to the present invention.

FIG. 12 shows that if there are two or more SPEs, segment switching between SPEs can occur. FIG. 13 shows that when there are two SPEs, segment switching between SPEs is also RF signal-based, so it is the same as the segment switching described above. However, segments belonging to different SPEs are not grouped.

On the other hand, for stationary wireless charging, it is assumed that there is only one segment.

As described above, although the present invention has been described with reference to limited embodiments and drawings, the present invention is not limited thereto. It will be apparent to those skilled in the art that various modifications and variations can be made within the scope of the technical idea of the present invention and the scope of equivalents of the appended claims.

What is claimed is:

1. A method for wireless charging of stationary and moving electric vehicles using two-way communication by one or more supply power electronic devices, the method comprising:
(a) transmitting a periodic RF signal through at least one supply power P2P communication controller by the supply power electronic device;
(b) checking whether a response signal to the RF signal transmitted in step (a) is received;
(c) checking, if the response signal is received in step (b), a wireless charging required value of the received response signal; and
(d) determining on/off switching of a segment where the supply power P2P communication controller is located, according to the checking result of the step (c).

2. The method of claim 1, wherein the turning-on of the segment switching in step (d) is when the response signal to the RF signal of step (a) is received and the wireless charging required value of the received response signal in step (c) is 1.

3. The method of claim 1, wherein the turning-off of the segment switching in step (d) is when the response signal to the RF signal of step (a) is not received.

4. The method of claim 1, wherein the turning-off of the segment switching in step (d) is when the response signal to the RF signal of step (a) is received and the wireless charging required value of the received response signal is 0.

5. The method of claim 1, wherein the turning-on of the segment switching in step (d) is divided into individual segment switching on and group segment switching on.

6. The method of claim 5, wherein the group segment uses either an overlapping method or a non-overlapping method.

7. The method of claim 5, wherein the division is determined by the speed of the electric vehicle included in the response signal.

8. A device for wireless charging of stationary and moving electric vehicles using two-way communication by one or more supply power electronic devices, the device comprising:
at least one processor; and
at least one memory storing computer-executable instructions,
wherein the computer-executable instructions stored in the at least one memory, when executed by the at least one processor, cause the device to perform:
(a) transmitting a periodic RF signal through at least one supply power P2P communication controller by the supply power electronic device;
(b) checking whether a response signal to the RF signal transmitted in step (a) is received;
(c) checking, if the response signal is received in step (b), a wireless charging required value of the received response signal; and
(d) determining on/off switching of a segment where the supply power P2P communication controller is located, according to the checking result of the step (c).

9. A method for wireless charging of stationary and moving electric vehicles using two-way communication, the method comprising:
(a) receiving an RF signal by a vehicle P2P communication controller of the electric vehicle;
(b) identifying an ID of a supply power electronic device from the RF signal received in the step (a); and
(c) transmitting a response signal including a wireless charging required value to the supply power electronic device identified in the step (b) and turning on/off a battery switch of the electric vehicle.

10. The method of claim 9, wherein the response signal is determined according to whether the battery of the electric vehicle is fully charged.
